(19) United States
(12) Patent Application Publication
(10) Pub. No.: US 2021/0188213 A1
(43) Pub. Date: Jun. 24, 2021

(54) SYSTEM AND METHOD FOR USING ON-VEHICLE SENSORS FOR SECURITY MONITORING

(71) Applicant: Continental Automotive Systems, Inc., Auburn Hills, MI (US)

(72) Inventors: Ryan Stabel, Grand Blanc, MI (US); Maria Nohemi Bravo Solis, Rochester Hills, MI (US); Mariano Raul Gonzalez Tokman, Rochester Hills, MI (US)

(73) Assignee: Continental Automotive Systems, Inc., Auburn Hills, MI (US)

(21) Appl. No.: 16/718,393

(22) Filed: Dec. 18, 2019

(51) Int. Cl. B60R 25/30; B60R 25/104; B60W 50/14

(52) U.S. Cl. CPC B60R 25/305; B60R 25/104; B60W 50/14; B60R 2325/202; B60R 2300/8073; B60W 2050/143; B60R 2300/60; B60W 2420/52; B60W 2420/42; B60R 2300/301; B60W 2420/54; B60W 2050/146

(57) ABSTRACT

A method security monitors a parked vehicle's surroundings. The vehicle has a plurality of motion activated sensors mounted on the vehicle to obtain data regarding an area near the vehicle. The vehicle includes a controller. mounted on the vehicle, electrically connected with the plurality of sensors to receive the data from the sensors and to process the data to identify activity in the area near the vehicle. With the vehicle parked and the ignition off, at least one of the plurality of sensors senses activity occurring in the area near the vehicle. When activity is determined to be occurring in the sensed area near the vehicle, certain ones of the plurality of sensors monitors the area near the vehicle and provides data to the controller indicative of the activity occurring in the area near the vehicle. A system is also provided.

### FIELD

This disclosure relates to a vehicle and, more particularly, to a system and method for using vehicle sensors for security monitoring an area near the vehicle.

### BACKGROUND

The use of security systems reduces the risk of theft, property damage and home or business break-ins. Such systems can include externally mounted cameras to obtain images outside of the home or business to provide further security. Thus, these additional cameras and wiring add to the overall cost of the security system.

Current vehicles have advanced driver assistance systems that includes various on-board sensors such as cameras, LIDAR, RADAR, ultrasonic, etc. to assist the driver of the vehicle in operating the vehicle while in motion. However, such sensors are inactive when the vehicle is parked with the ignition off.

Thus, there is a need to provide a system and method for a parked vehicle, to monitor the vehicle's surroundings as a security system using the on-board sensors of the vehicle, and to provide a notification if unusual activity occurs.

### SUMMARY

An objective of an embodiment is to fulfill the need referred to above. In accordance with the principles of an embodiment, this objective is obtained by providing a system for monitoring a parked vehicle's surroundings. The system includes a plurality of automatically activated sensors mounted on the vehicle and constructed and arranged to obtain data regarding an area near the vehicle. A controller, mounted on the vehicle, is electrically connected with the plurality of sensors to receive the data from the sensors and to process the data to identify activity occurring in the area near the vehicle. The controller includes a power module constructed and arranged to provide a first voltage from a battery of the vehicle to the plurality of sensors defining an active sensing mode, and to provide a second voltage from the battery to the plurality of sensors defining a security monitoring mode, with the second voltage being greater than the first voltage. When the vehicle is parked and the ignition is off and when at least one of the plurality of sensors in the active sensing mode senses activity in the area near the vehicle, the power module is constructed and arranged to provide the second voltage to the plurality of sensors so that the plurality of sensor are fully operative in the security monitoring mode to provide the data to the controller indicative of the activity occurring in the area near the vehicle.

In accordance with another aspect of an embodiment, a method is provided for monitoring a parked vehicle's surroundings. The vehicle has a plurality of automatically activated sensors mounted on the vehicle and constructed and arranged to obtain data regarding an area near the vehicle, and a controller, mounted on the vehicle, electrically connected with the plurality of sensors to receive the data from the sensors and to process the data to identify activity occurring in the area near the vehicle. With the vehicle parked and the ignition off, the controller places the plurality of sensors in a low power, active sensing mode, and when at least one of the plurality of sensors in the active sensing mode senses activity in the area surrounding the vehicle, the controller places the plurality of sensors in a fully operative, security monitoring mode and providing the data to the controller indicative of the activity occurring in the area near the vehicle.

In accordance with yet another aspect of an embodiment, a method is provided for monitoring a parked vehicle's surroundings. The vehicle has a plurality of motion activated sensors mounted on the vehicle and constructed and arranged to obtain data regarding an area near the vehicle, and a controller, mounted on the vehicle, electrically connected with the plurality of sensors to receive the data from the sensors and to process the data to identify activity in the area near the vehicle. With the vehicle parked and the ignition off, the method senses by at least one of the plurality of sensors, activity occurring in the area near the vehicle, and when the activity is determined to be occurring in the sensed area near the vehicle, the method monitors, by certain ones of the plurality of sensors, the area near the vehicle and provides data to the controller indicative of the activity occurring in the area near the vehicle.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a perspective view of an exemplary vehicle having a system, for providing security to an area near the vehicle, in accordance with an embodiment of the invention.

FIG. 2 is a schematic view of the system of FIG. 1.

FIG. 3 is a flowchart of method steps of an embodiment.

### DETAILED DESCRIPTION OF THE EXEMPLARY EMBODIMENTS

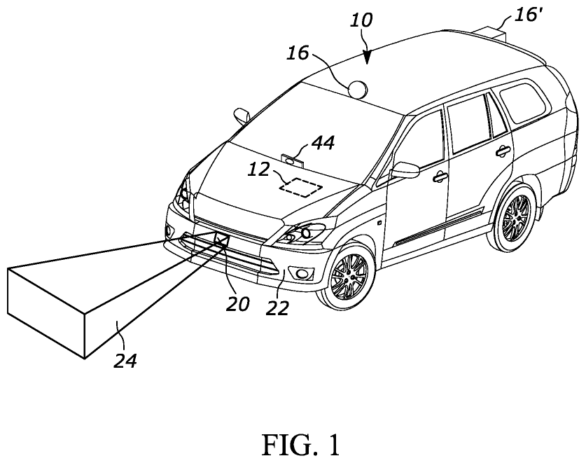

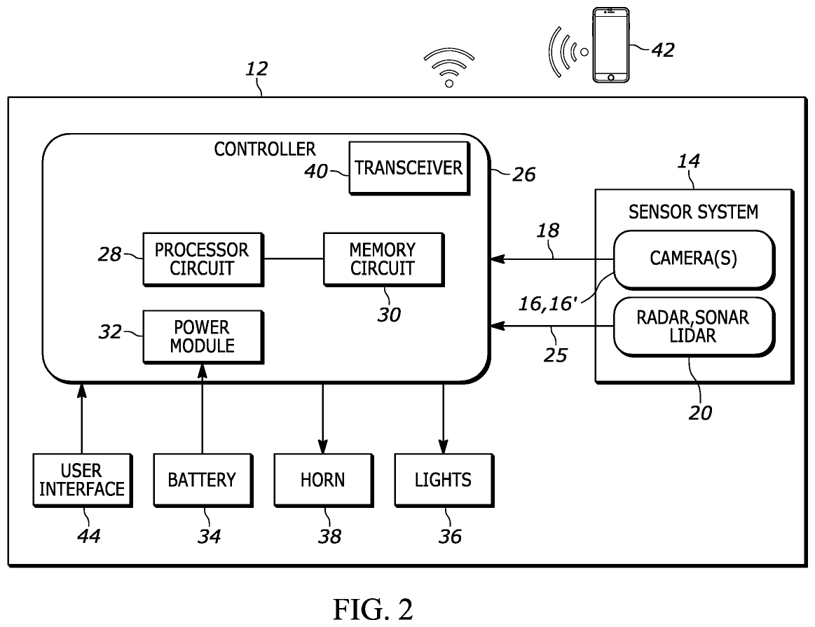

With reference to FIG. 1, a vehicle, generally indicated at 10, has a system 12 that provides security monitoring for a home, business, or other vehicle surroundings in accordance with an embodiment. As best shown in FIG. 2, the system 12 includes a sensor system 14 that includes a plurality of different types of sensors that may be used separately or with one another to create a perception of the environment near the vehicle 10. The sensor system 14 aids the driver in making intelligent decisions based on objects and obstacles detected by the sensor system 14 as the vehicle 10 is moving and can aid in autonomously maneuvering the vehicle 10. The sensor system 14 may include one or more cameras (such as a front camera 16 and rear camera 16′) supported by the vehicle to capture image signals 18 of the environment near or surrounding the vehicle 10. The camera 16 is a front facing camera that is mounted near the front portion of the vehicle 10 to provide a view in front of the vehicle. The camera 16′ is a rear facing camera that is mounted near the rear portion of the vehicle 10 to provide a view behind the vehicle. In some examples, the cameras 16, 16′ are preferably automatically activated such as by motion or sound, or light. Other camera types may also be used such as a fisheye camera or other cameras that can provide an overhead view of the vehicle 10.

The sensor system 14 includes other sensors 20 such as radar. sonar or ultrasonic, LIDAR (Light Detection and Ranging, which can entail optical remote sensing that measures properties of scattered light to find range and/or other information of a distant target), LADAR (Laser Detection and Ranging) configured to determine a range, angle, or velocity of objects. In the embodiment, the sensor 20 is preferably a LIDAR or ultrasonic sensor that is typically mounted on the exterior of the vehicle 10, for example on the front bumper 22, or the side of the vehicle 10 such as between the doors, or on the rear of the vehicle or any other place in or out of the vehicle so as to illuminate an area outside of the vehicle with laser light 24 and detects, via signal 25, the reflection of the laser light from objects disposed in the lighted area. Sensor 20 is also preferably automatically activated by motion, sound, or light.

The system 12 includes a controller 26 that receives the signals 18 from the cameras 16, 16′ and the signal 25 from the sensor 20. The controller 26 includes a computing device such as a processor circuit 28 central processing unit having one or more computing processors) in communication with a non-transitory memory circuit 30 (e.g., a hard disk, flash memory, random-access memory) capable of storing instructions executable by the processor circuit 28.

The controller 26 also includes a power module 32 electrically connected to the vehicle battery 34 and configured to provide a first or low (minimal) voltage to the sensor 20 and cameras 16, 16′ in a “sleep” mode. The sleep mode is when the vehicle is parked and the ignition is off with the sensor 20 and cameras 16, 16′ drawing minimal battery power while in an active sensing mode. If the motion activated cameras 16, 16 sense motion, sound or light occurring externally near the vehicle 10 and/or the sensor 20 detects, via motion, sound or light, an object a certain distance from the vehicle 10, the power module 34 is configured to provide a second voltage (greater than the minimal, first voltage) or full power to the sensor 20 and cameras 16, 16. horn 38 and lights 36 in an “awake” mode. In the awake mode, the vehicle 10 remains parked with the ignition off, with the sensor 20 and cameras 16, 16′, horn 38 and lights 36 fully operative in a security monitoring mode. Thus, in the awake mode, the image signals 18 from the cameras 16, 16′ and optionally, the signal 25 from sensor 20 are received by the controller 26 which can record the image signals 18, automatically activate the vehicle's lights 36 and/or sound the vehicle's horn 38 so as to deter perpetrators in the area under surveillance by the vehicle 10.

In addition, the controller 26 includes a transceiver 40 that communicates wirelessly with a smartphone 42. Thus, if the system 12 is in the awake mode (security monitoring mode), the transceiver 40 can automatically send a text message to the vehicle owner's or homeowner's smartphone 42, warning of an unexpected behavior occurring around the vehicle 10, and can automatically transmit images and/or video from obtained from the cameras 16, 16′.

The system 12 includes a user interface 44 that receives one or more user commands from the driver via one or more input mechanisms such as a touch screen display for activating the security system 12 (placing the plurality of sensors 16, 16′, 20 in the active sensing mode). Once activated with the vehicle parked and the ignition off, the system 12 is in the active sensing mode and will automatically awake to the security monitoring mode if the appropriate motion is detected as noted above. Alternatively, to arm the system 12 (place the plurality of sensors 16, 16′, in the active sensing mode), the vehicle owner can use the smartphone 42 as a user interface instead of using interface 44. Once the vehicle ignition is started, the vehicle will operate normally, with the sensor system 14 fully operative for aid in driving the vehicle.

In order to prevent false positive motion sensing, the system 12 can be configured via the interface 44 to only respond to certain situations, e.g., a user defined geographical area such as the owner's home, a user defined time period such as only at night, etc.

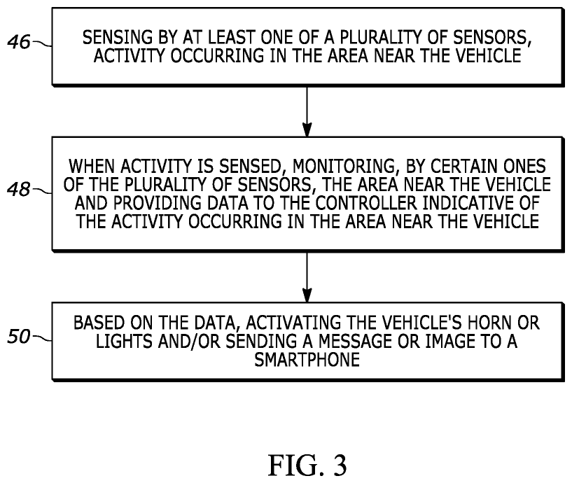

With reference to FIG. 3. method steps for security monitoring an area near a vehicle 10 with the vehicle parked and the ignition off includes, in step 46, automatically sensing activity by at least one of the plurality of sensors 16, 16, 20, such as sensing motion, sound or light occurring in the area near the vehicle. In step 48, when activity in the area near the vehicle is sensed, the method includes monitoring, by certain ones of the plurality of sensors (e.g., 16, 16′), the area near the vehicle and providing data to the controller indicative of activity occurring in the area near the vehicle. In step 50, based on the data, the vehicle's horn 38 or lights 36 are activated and/or a message or image is sent by the controller 26 to the smartphone 42.

Thus, the system 12 advantageously provides security for the exterior of a home or business near the parked vehicle 10 and can also provide security for a space in which the vehicle is enclosed, such as a garage or warehouse by employing the existing on-board vehicle sensor system 14 to monitor the vehicle's surroundings. The vehicle 10 can be an internal combustion vehicle, with the battery 34 being the vehicle's 12V battery, or the vehicle 10 can be a hybrid or entirely electrically operated vehicle that uses one of the batteries of the battery pack as the system 12 power source.

Various implementations of the systems and techniques described here (e.g., processor circuit 28, power module 32) can be realized in digital electronic circuitry, integrated circuitry, specially designed ASICs (application specific integrated circuits), computer hardware, firmware, software. and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. Implementations of the subject matter and the functional operations described in this specification can be implemented in digital electronic circuitry, or in computer software, firmware, or hardware. including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A system for monitoring a parked vehicle's surroundings comprising:
a plurality of automatically activated sensors mounted on the vehicle and constructed and arranged to obtain data regarding an area near the vehicle, and
a controller, mounted on the vehicle, electrically connected with the plurality of sensors to receive the data from the sensors and to process the data to identify activity occurring in the area near the vehicle, the controller including a power module constructed and arranged to provide a first voltage from a battery of the vehicle to the plurality of sensors defining an active sensing mode, and, to provide a second voltage from the battery to the plurality of sensors defining a security monitoring mode, with the second voltage being greater than the first voltage,
wherein, when the vehicle is parked and the ignition is off and when at least one of the plurality of sensors in the active sensing mode senses activity in the area near the vehicle, the power module is constructed and arranged to provide the second voltage to the plurality of sensors so that the plurality of sensor are fully operative in the security monitoring mode to provide the data to the controller indicative of the activity occurring in the area near the vehicle.

2. The system of claim 1, wherein the plurality of sensors includes at least a front facing camera, a rear facing camera, or an overhead view camera and the data includes images of the area near the vehicle.

3. The system of claim 1, wherein at least one of the plurality of sensors is a radar, sonar, ultrasonic, LIDAR sensor, or camera and is constructed and arranged to be automatically activated by one of motion, sound or light as the sensed activity.

4. The system of claim 1, wherein the vehicle includes a horn and lights, the controller being constructed and arranged to activate the horn or lights based on the data provided to the controller by the plurality of sensors indicative of activity in the area near the vehicle.

5. The system of claim 2, wherein the controller further comprises a transceiver constructed and arranged to wirelessly communicate with a smartphone, wherein, based on the data provided to the controller by the plurality of sensors, the controller is constructed and arranged to send a message or at least one image obtained by at least one of the cameras to the smartphone, indicating activity is present in the area near the vehicle.

6. The system of claim 5, wherein the transceiver is constructed and arranged to receive a signal from the smartphone to place the plurality of sensors in the active sensing mode.

7. The system of claim 1, further comprising a user interface in the vehicle constructed and arranged to receive a user input to place the plurality of sensors in the active sensing mode.

8. A method of monitoring a parked vehicle's surroundings, the vehicle having a plurality of activity activated sensors mounted on the vehicle and constructed and arranged to obtain data regarding activity occurring in an area near the vehicle, and a controller, mounted on the vehicle, electrically connected with the plurality of sensors to receive the data from the sensors and to process the data to identify the activity occurring in the area near the vehicle, the method comprising the steps of:
with the vehicle parked and the ignition off:
placing, by the controller, the plurality of sensors in a low power, active sensing mode, and
when at least one of the plurality of sensors in the active sensing mode senses activity in the area surrounding the vehicle, placing, by the controller, the plurality of sensors in a fully operative, security monitoring mode and providing the data to the controller indicative of the activity occurring in the area near the vehicle.

9. The method of claim 8, wherein the controller comprises a power module electrically connected with a battery of the vehicle, the step of a placing the plurality of sensors in the low power, active sensing mode comprises:
sending from the power module to the plurality of sensors, a first voltage, and
the step of placing the plurality of sensors in the fully operative, security monitoring mode comprises:
sending from the power module to the plurality of sensors, a second voltage that is greater than the first voltage.

10. The method of claim 8, wherein the plurality of sensors includes at least a front facing camera, a rear facing camera, or an overhead view camera and the data includes images of the area near the vehicle, wherein, based on the data provided to the controller by the plurality of sensors, the method further comprises:
sending, by the controller, a message or an image obtained by at least one of cameras to a smartphone, indicating activity is occurring in the area near the vehicle.

11. The method of claim 8, wherein at least one of the plurality of sensors is a radar, sonar, ultrasonic, LIDAR sensor, or camera and is constructed and arranged to be automatically activated by one of motion, sound or light as the sensed activity.

12. The method of claim 8, wherein the vehicle includes a horn and lights, the method further comprises:
activating, by the controller, the horn or lights based on the data provided to the controller by the plurality of sensors to indicate occurrence of activity in the area near the vehicle.

13. The method of claim 8, wherein the step of to place the plurality of sensors in the active sensing mode comprises:
receiving, at the controller, a signal from a smartphone.

14. The method of claim 8, wherein the step of to place the plurality of sensors in the active sensing mode comprises:
providing an input to a user interface disposed in the vehicle.

15. The method of claim 8, wherein the area near the vehicle is a portion of an exterior of a home or business.

16. The method of claim 8, wherein the area near the vehicle is an enclosed space in which the vehicle resides.

17. A method of monitoring a parked vehicle's surroundings, the vehicle having a plurality of motion activated sensors mounted on the vehicle and constructed and arranged to obtain data regarding an area near the vehicle. and a controller, mounted on the vehicle, electrically connected with the plurality of sensors to receive the data from the sensors and to process the data to identify activity in the area near the vehicle, the method comprising the steps of:
with the vehicle parked and the ignition off:
sensing by at least one of the plurality of sensors, activity occurring in the area near the vehicle, and
when activity is determined to be occurring in the sensed area near the vehicle, monitoring, by certain ones of the plurality of sensors, the area near the vehicle and providing data to the controller indicative of the activity occurring in the area near the vehicle.

18. The method of claim 17, wherein the certain ones of the plurality of sensors include at least a front facing camera, a rear facing camera, or an overhead view camera and the data includes images of the area near the vehicle, wherein, based on the data provided to the controller, the method further comprises:
sending, by the controller, a message or an image obtained by at least one of cameras to a smartphone, indicating activity is occurring in the area near the vehicle.

19. The method of claim 17, wherein the vehicle includes a horn and lights, the method further comprises:
activating, by the controller, the horn or lights based on the data provided to the controller by the certain ones of the plurality of sensors to indicate occurrence of activity in the area near the vehicle.

20. The method of claim 17, wherein the step of sensing activity includes sensing motion, sound or light.
